(19) United States
(12) Patent Application Publication
(10) Pub. No.: US 2015/0135891 A1
(43) Pub. Date: May 21, 2015

(54) Handlebars for a vehicle

(71) Applicant: NEKEN, Murs Erigne (FR)

(72) Inventor: Philippe Bochereau, Murs Erigne (FR)

(73) Assignee: NEKEN, Murs Erigne (FR)

(21) Appl. No.: 14/180,576

(22) Filed: Feb. 14, 2014

(30) Foreign Application Priority Data
Nov. 18, 2013 (FR) 13/61256

(51) Int. Cl. B62K 21/12; B62K 21/26

(52) U.S. Cl. CPC B62K 21/12; B62K 21/26
USPC 74/551.9

(57) ABSTRACT

The present invention relates to handlebars for a vehicle comprising: a central part intended to be secured to a steering member of the vehicle and taking the form of a hollow cylinder having a first outside diameter, at each end of the central part, an intermediate part taking the form of a hollow cylinder having a second outside diameter smaller than said first diameter, and connected to said end by means of a first adaptation part, for each intermediate part, an end part in line with said intermediate part, taking the form of a hollow cylinder having a third outside diameter smaller than said second diameter, and connected to said intermediate part by means of a second adaptation part, said third outside diameter being less than or equal to 21 mm, and for one of the end parts, a gas grip fitting on said end part and a flexible grip fitting on said gas grip, and for the other end part, a flexible grip fixed to said other end part.

### BACKGROUND

The present invention concerns handlebars for a vehicle that may be motorised or not, as well as a vehicle, such as a motorcycle, a bicycle, a quad bike, etc, comprising such handlebars.

Handlebars of the prior art consist of a hollow tube that has a central part that is fixed to the steering member of the vehicle by means of connectors, generally two in number, and two end parts with a diameter of 22.15 mm disposed on either side of the central part and secured thereto.

The left-hand end part receives a cylindrical grip made from flexible material such as rubber, which fits onto the free end of said end part.

The right-hand end part receives a rotary gas grip in the form of a rigid cylindrical sleeve that fits onto the free end of said end part and a cylindrical grip made from flexible material that fits onto the rotary gas grip.

The flexible grips that are currently used have an outside diameter of around 28 to 31 mm, which is particularly large, in particular when the rider of the vehicle has small hands, such as for example a child.

One object of the present invention is therefore to propose handlebars that do not have the drawbacks of the prior art and in particular make it possible to fit flexible grips with a smaller diameter for easier handling for riders having small hands, or flexible grips keeping the same outside diameter as those of the prior art but with a greater thickness of flexible material to provide greater comfort through better absorption of shocks and vibrations.

### SUMMARY

To this end, handlebars for a vehicle are proposed comprising:

a central part intended to be secured to a steering member of the vehicle and taking the form of a hollow cylinder having a first outside diameter,

at each end of the central part, an intermediate part taking the form of a hollow cylinder having a second outside diameter smaller than said first diameter, and connected to said end by means of a first adaptation part,

for each intermediate part, an end part in line with said intermediate part, taking the form of a hollow cylinder having a third outside diameter smaller than said second diameter, and connected to said intermediate part by means of a second adaptation part, said third outside diameter being less than or equal to 21 mm, and

for one of the end parts, a gas grip fitting on said end part and a flexible grip fitting on said gas grip, and

for the other end part, a flexible grip fixed to said other end part.

Advantageously, each end part consists of a cylinder fitting on and fixed to the inside of the associated intermediate part.

Advantageously, the outside diameter of the gas grip is approximately 2 mm larger than the inside diameter thereof.

According to a first embodiment, the outside diameter of each flexible grip is around 28 to 31 mm.

According to a second embodiment, the outside diameter of each flexible grip is around 26 mm.

The invention also proposes a vehicle comprising a steering member and handlebars according to one of the above variants, the central part of which is fixed to said steering member.

### BRIEF DESCRIPTION OF THE DRAWINGS

The features of the invention mentioned above, as well as others, will emerge more clearly from a reading of the following description of an example embodiment, said description being given in relation to the accompanying drawings, among which:

FIG. 1 shows handlebars according to the invention,

FIG. 2 is a section along the straight line II-II in FIG. 1 of the handlebars in FIG. 1,

FIG. 3 is a section along the straight line III-III of the handlebars in FIG. 1, and

FIG. 4 is a section along the line II-II of handlebars according to another embodiment of the invention.

### DETAILED DESCRIPTION

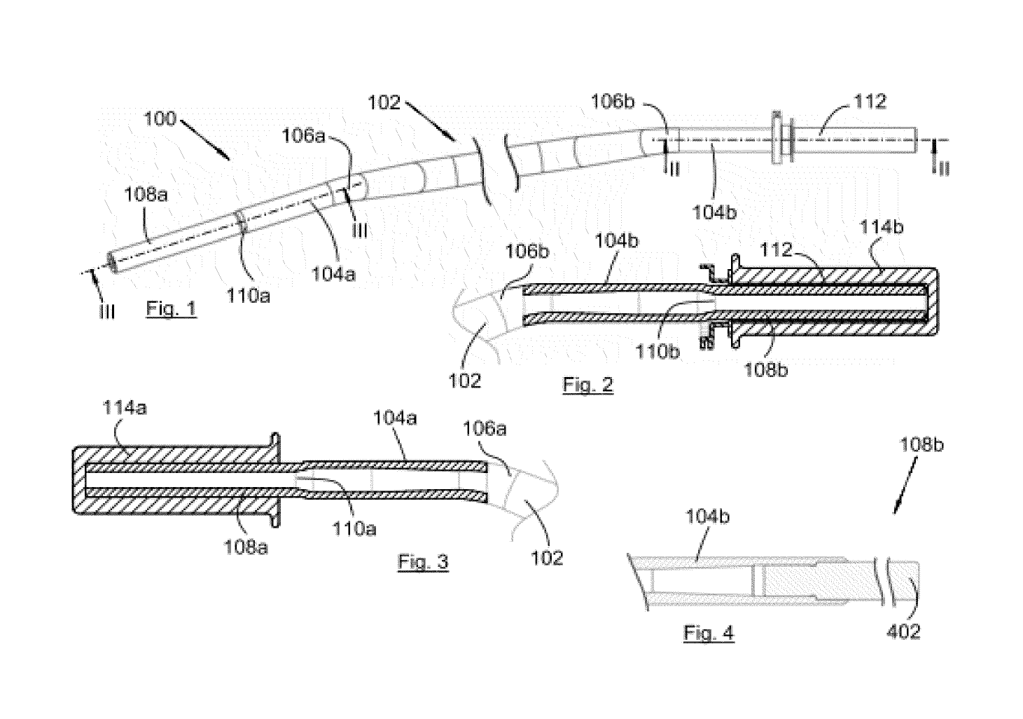

FIG. 1 shows handlebars 100 that comprise a central part 102 intended to be secured, by means of connectors (not shown), to a steering member of a vehicle, such as the forks of a motorcycle.

FIG. 2 shows a cross section of the handlebars 100 on the side where the rotary gas grip 112 is, and FIG. 3 shows a cross section of the handlebars 100 on the other side.

The central part 102 takes the form of a hollow cylinder having a first outside diameter, which is advantageously 28.6 mm, or even more.

At each end of the central part 102, the handlebars 100 have an intermediate part 104a-b, taking the form of a hollow cylinder having a second outside diameter less than said first diameter, and which is here advantageously equal to 22.15 mm.

The connection between the end of the central part 102 and the corresponding intermediate part 104a-b is made by means of a first adaptation part 106a-b that is produced between said end and said intermediate part 104a-b and provides the reduction in the outside diameter of the handlebars 100 from the first diameter to the second diameter.

The handlebars 100 also comprise, for each intermediate part 104a-b, an end part 108a-b in line with said intermediate part 104a-b opposite to the central part 102. Each end part 108a-b takes the form of a hollow cylinder having a third outside diameter less than said second diameter. The third outside diameter is less or equal to 21 mm.

The connection between the intermediate part 104a-b and the associated end part 108a-b is made by means of a second adaptation part 110a-b that is produced between said intermediate part 104a-b and said end part 108a-b and provides the reduction in the outside diameter of the handlebars 100 from the second diameter to the third diameter.

The gas grip 112 is in the form of a sleeve produced from a hard material such as a hard plastics material or a metal.

The gas grip 112 fits onto one of the end parts, here the end part 108b on the right, and has an inside diameter adapted to the third diameter to allow the fitting and free rotation of the gas grip 112. The gas grip 112 has an outside diameter that is approximately 2 mm larger than the inside diameter thereof. The inside diameter of the gas grip 112 is approximately 0.5 mm larger than the third diameter.

A flexible grip 114b made from flexible material such as rubber fits onto the gas grip 112.

The flexible grip 114b has an inside diameter adapted to the outside diameter of the gas grip 112 in order to provide good attachment between the gas grip 112 and the flexible grip 114b after fitting.

If the outside diameter of the flexible grip 114b is kept to a standard value, that is to say around 28 to 31 mm, the reduction in the third outside diameter makes it possible to obtain better comfort for the rider, since such an arrangement makes it possible to obtain a flexible grip 114b that is thicker compared with a flexible grip of the prior art.

If the diameter of the flexible grip 114b is reduced compared with a standard value, so as to preferably achieve 26 mm, the reduction in the third outside diameter improves the holding for riders with small hands without comfort being reduced since sufficient thickness of the flexible grip is preserved.

A flexible grip 114a is fixed to the other end part, here the end part 108a on the left, and has an outside diameter adapted to the third diameter in order to ensure fitting and good attachment between the end part 108a and the flexible grip 114a. The flexible grip 114a is fixed by fitting or overmoulding on the end part 108a.

The flexible grip 114a is also made from flexible material such as rubber.

As with the aforementioned flexible grip 114b, if the outside diameter of the flexible grip 114a is kept to a standard value, that is to say around 28 to 31 mm, the reduction in the third outside diameter makes it possible to obtain better comfort for the rider since such an arrangement makes it possible to obtain a flexible grip 114a that is thicker compared with a flexible grip of the prior art.

And, if the diameter of the flexible grip 114a is reduced compared with a standard value, so as to attain for example 26 mm, the reduction in the third outside diameter improves the holding for riders with small hands without comfort being reduced since sufficient thickness of the flexible grip is preserved.

FIG. 4 shows handlebars according to another embodiment of the invention.

When the third outside diameter is too small and the end part 108a, 108b risks deforming or breaking, said end part 108a-b consists of a cylinder 402 that is fitted and fixed inside the intermediate part 104a-b.

The cylinder 402 is produced from any suitable material and preferably metal.

The cylinder 402 can be fixed by any suitable method such as screwing, crimping, adhesive bonding, welding, the fitting of a pin, etc.

The cylinder 402 may be solid, or hollowed out over part of the length thereof or over the entire length thereof.

Naturally the present invention is not limited to the examples and embodiments described and depicted but is capable of numerous variants accessible to a person skilled in the art.

1-6. (canceled)

7. Handlebars for a vehicle, comprising:
a central part intended to be secured to a steering member of the vehicle and taking the form of a hollow cylinder having a first outside diameter,
at each end of the central part, an intermediate part taking the form of a hollow cylinder having a second outside diameter smaller than said first diameter, and connected to said end by means of a first adaptation part,
for each intermediate part, an end part in line with said intermediate part, taking the form of a hollow cylinder having a third outside diameter smaller than said second diameter, and connected to said intermediate part by means of a second adaptation part, said third outside diameter being less than or equal to 21 mm, and
for one of the end parts, a gas grip fitting on said end part and a flexible grip fitting on said gas grip, and
for the other end part, a flexible grip fixed to said other end part.

8. Handlebars according to claim 7, wherein each end part consists of a cylinder fitting and fixed inside the associated intermediate part.

9. Handlebars according to claim 7, wherein the gas grip has an outside diameter and an inside diameter and wherein the outside diameter is 2 mm larger than the inside diameter.

10. Handlebars according to claim 7, wherein each flexible grip has an outside diameter which is around 28 to 31 mm.

11. Handlebars according to claim 7, wherein each flexible grip has an outside diameter which is around 26 mm.

12. Vehicle comprising a steering member and handlebars according to claim 7, the central part of which is fixed to said steering member.
